(19) United States
(12) Patent Application Publication
(10) Pub. No.: US 2003/0151594 A1
(43) Pub. Date: Aug. 14, 2003

(54) Mouse with an optical encoder wheel for a computer

(76) Inventor: Huo-Lu Tsai, Taichung Hsien (TW)

Correspondence Address: MERCHANT & GOULD PC, P.O. BOX 2903, MINNEAPOLIS, MN, 55402-0903, US

(21) Appl. No.: 10/091,967

(22) Filed: Mar. 5, 2002

(30) Foreign Application Priority Data
Feb. 8, 2002 (TW) 91201786

(51) Int. Cl. G09G 5/08

(52) U.S. Cl. 345/163

(57) ABSTRACT

A mouse includes a housing, a wheel disposed rotatably in the housing and movable in a radial direction between upper and lower positions, a shaft extending through a center of the wheel and secured thereto, a detecting unit for detecting movement of the wheel, and a spring unit mounted in the housing and having two opposing coil parts that are respectively sleeved on two opposite ends of the shaft. Each of the coil parts has opposing end sections that diverge therefrom to slidably abut against the housing so as to suspend the wheel in the housing and that define an angle therebetween. The angle is enlarged when the wheel is moved from the upper position to the lower position, thereby providing an urging force to move the wheel from the lower position to the upper position.

### BACKGROUND OF THE INVENTION

1. Field of the Invention

This invention relates to a mouse for a computer, more particularly to an optical mouse with an optical encoder wheel which is rotatable and pressable to provide electrical signals to a computer.

2. Description of the Related Art

FIG. 1 illustrates a conventional optical mouse for a computer. The optical mouse includes a housing 4 (only a portion is shown), a circuit board 5 disposed in the housing 4 for providing electrical signals to a computer (not shown), an optical encoder wheel 6 mounted rotatably in the housing 4 above the circuit board 5 and formed with a plurality of radial slots 6011, a light transmitter 502 electrically connected to the circuit board 5 and disposed at one side of the optical encoder wheel 6 for emitting a light to pass through the radial slots 6011 in the optical encoder wheel 6, and a light receiver 503 electrically connected to the circuit board 5 and disposed at the other side of the optical encoder wheel 6 for receiving the light from the light transmitter 502 and for generating an electrical signal indicating the direction and amount of rotation of the optical encoder wheel 6. The optical encoder wheel 6 includes a wheel body 601 that has an inner wall formed with a plurality of grooves 6013, and a shaft 6012 that extends axially through a center of the wheel body 601. The optical encoder wheel 6 is rotatably mounted in the housing 4 via an assembly that includes a pair of opposing supporting arms 401 projecting from the circuit board 5 and formed with opposing notches 4011, a pair of guide posts 402 formed with opposing guide grooves 4021, and an actuator 602 that is formed with a pivot hole 6021 for extension of one end of the shaft 6012 therethrough, a spring-receiving groove 6023, and a spring-holding hole 6024, and that has a pair of guide wings 6022 which project into the guide grooves 4021 so as to permit the actuator 602 to be slidable along the guide posts 402. The optical encoder wheel 6 is movable together with the actuator 602 in a radial direction relative to the shaft 6012 from an upper position to a lower position, in which, a microswitch 501 is actuated by the actuator 602. An urging member 604, in the form of a coil spring, is sleeved rotatably on the other end of the shaft 6012, and has two opposite ends that are retained in the notches 4011 in the supporting arms 401 for urging the optical encoder wheel 6 to move from the lower position to the upper position. A friction member 603, in the form of a bent spring wire, has a bent end 6031 that is received in the spring-receiving groove 6023 and that relesably engages one of the grooves 6013 in the wheel body 601, and a fixing end 6032 that is retained in the spring-holding hole 6024. As such, rotation of the optical encoder wheel 6 can be sensed by a digit of the user.

Since the optical encoder wheel 6 and the actuator 602 are suspended in the housing 4 via the urging member 604, which is sleeved on only one end of the shaft 6012, radial movement of the optical encoder wheel 6 and the actuator 602 tends to be unbalanced, which can adversely affect actuation of the microswitch 501. Moreover, the actuator 602 has a complex configuration, and assembling the optical encoder wheel 6, the actuator 602, the urging member 604, and the friction member 603 is time-consuming.

### SUMMARY OF THE INVENTION

Therefore, the object of the present invention is to provide a mouse with a spring unit that is capable of overcoming the aforesaid drawbacks associated with the prior art.

According to the present invention, there is provided a mouse that is adapted to provide electrical signals to a computer. The mouse comprises: a housing; a wheel mounted rotatably in the housing and having left and right sides and a portion exposed from the housing for user operation; a shaft extending in an axial direction through a center of the wheel and secured thereto, the shaft having two opposite ends disposed at the left and right sides of the wheel, respectively, the wheel being operable to move together with the shaft in a radial direction relative to the shaft from an upper position to a lower position; a detecting unit disposed in the housing and adapted to provide electrical signals to the computer upon detecting movement of the wheel; and a spring unit mounted in the housing and including opposing first and second coil parts, each of which is sleeved on a respective one of the opposite ends of the shaft so as to permit rotation of the wheel together with the shaft relative to the first and second coil parts and so as to be movable together with the wheel and the shaft in the radial direction, and each of which has opposing first and second end sections that diverge therefrom to define an angle therebetween and that slidably abut against the housing so as to permit mounting of the wheel in the housing. The angle is enlarged when the wheel is moved together with the shaft and the first and second coil parts from the upper position to the lower position by an external force acting on the exposed portion of the wheel so as to provide an urging force to move the wheel together with the shaft and the first and second coil parts from the lower position to the upper position when the wheel is relieved from the external force.

### BRIEF DESCRIPTION OF THE DRAWINGS

In drawings which illustrate an embodiment of the invention,

FIG. 1 is a fragmentary partly exploded perspective view of a conventional optical mouse with an optical encoder wheel;

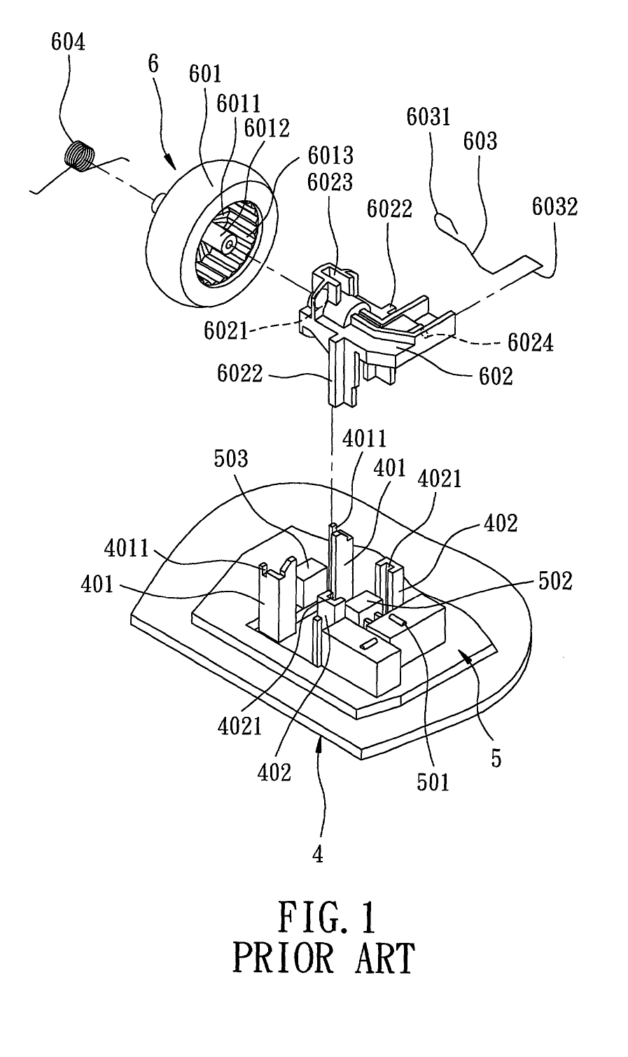

FIG. 2 is a fragmentary partly perspective view of the optical mouse of FIG. 1;

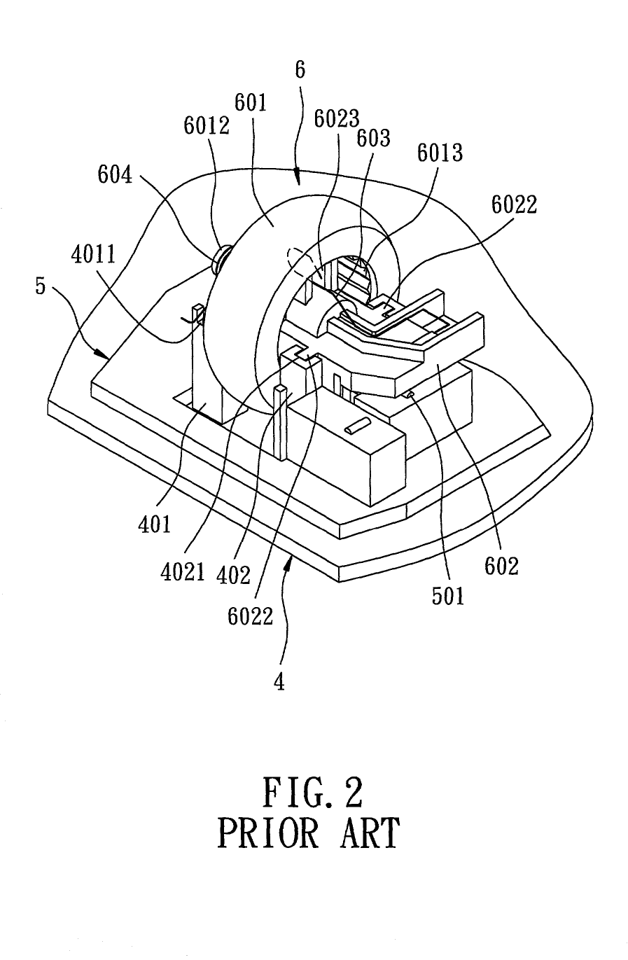

FIG. 3 is a perspective view of an optical mouse embodying this invention;

FIG. 4 is a fragmentary exploded perspective view of the optical mouse of FIG. 3;

FIG. 5 is a fragmentary perspective view of the optical mouse of FIG. 3, which is viewed from one side;

FIG. 6 is a fragmentary perspective view of the optical mouse of FIG. 3, which is viewed from another side; and

FIG. 7 is a fragmentary side view to illustrate how a spring unit moves in response to radial movement of an optical encoder wheel of the optical mouse of FIG. 3.

### DETAILED DESCRIPTION OF THE PREFERRED EMBODIMENT

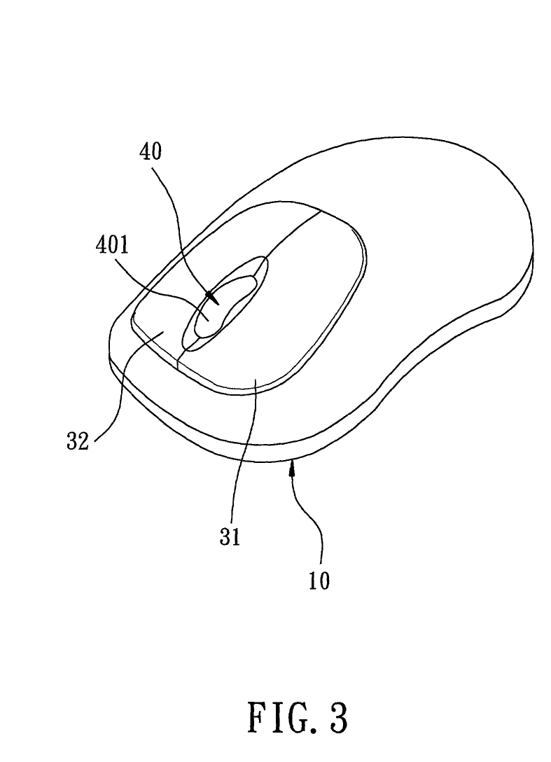

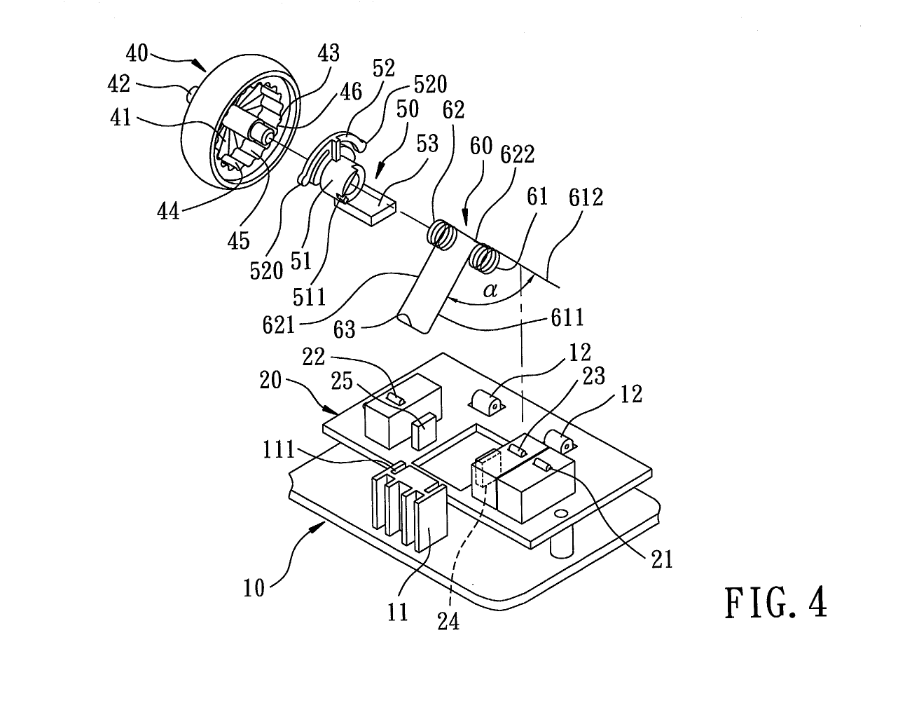

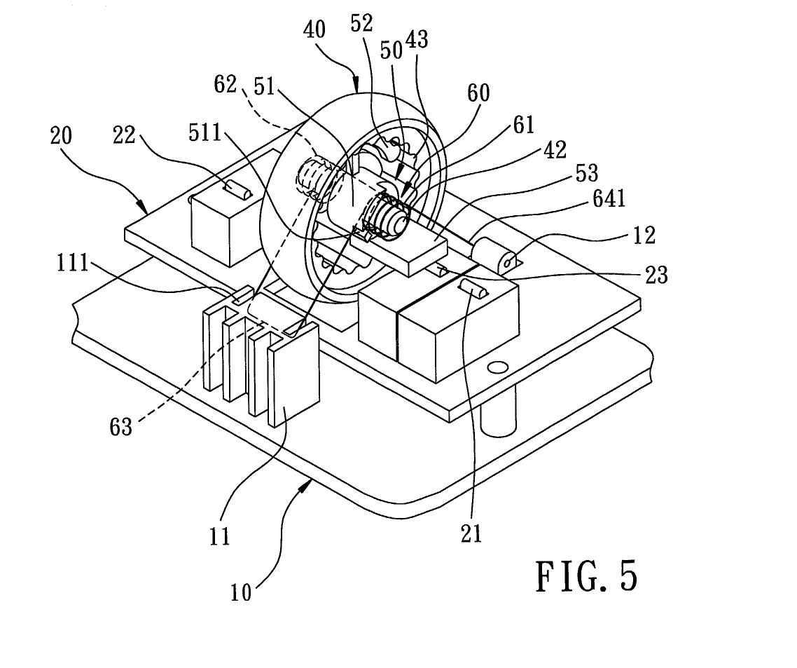

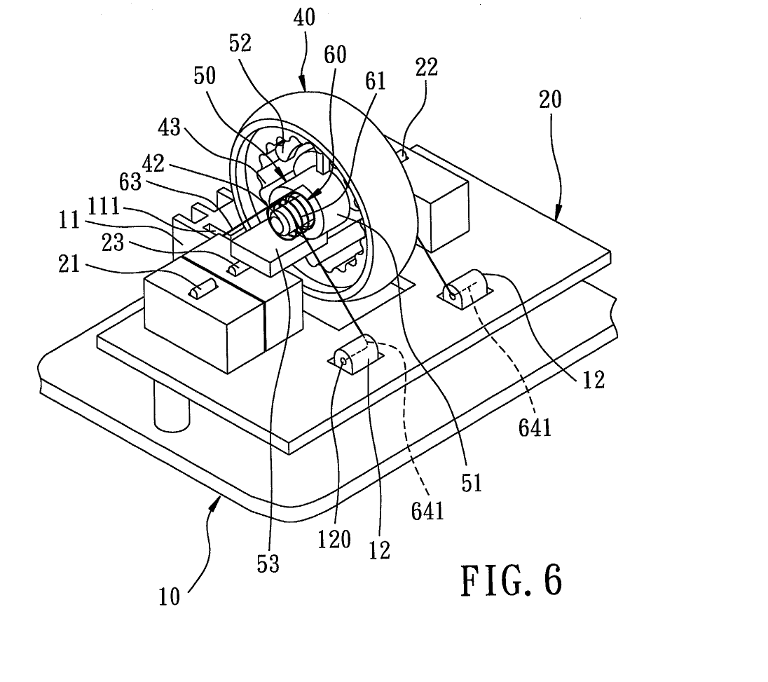

FIGS. 3 to 7 illustrate a preferred embodiment of a mouse of this invention for providing electrical signals to a computer (not shown).

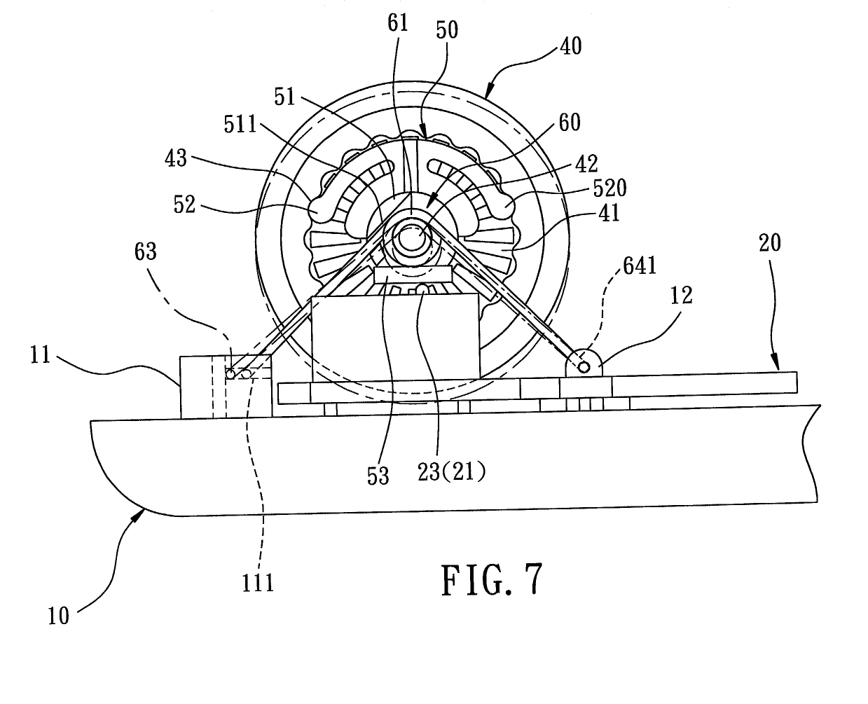

The mouse includes: a housing 10; first and second buttons 31, 32 exposed from the housing 10; a circuit board 20 mounted in the housing 10; first and second microswitches 21, 22 electrically connected to the circuit board 20 and actuated by the first and second buttons 31, 32, respectively; a wheel 40 mounted rotatably in the housing 10 and having a portion 401 exposed from the housing 10 for user operation; a shaft 42 extending in an axial direction through a center of the wheel 40 and secured thereto, the shaft 42 having two opposite ends disposed at opposite left and right sides of the wheel 40, the wheel 40 being operable to move together with the shaft 42 in a radial direction relative to the shaft 42 from an upper position to a lower position (see FIG. 7); a detecting unit disposed in the housing 10 and adapted to provide electrical signals to the computer upon detecting movement of the wheel 40; and a spring unit 60 mounted in the housing 10 and including opposing first and second coil parts 61, 62, each of which is sleeved on a respective one of the opposite ends of the shaft 42 so as to permit rotation of the wheel 40 together with the shaft 42 relative to the first and second coil parts 61, 62 and so as to be movable together with the wheel 40 and the shaft 42 in the radial direction, and each of which has opposing first and second end sections 611, 612 (621, 622) that diverge therefrom to define an angle (α) therebetween and that slidably abut against the housing 10 so as to permit mounting of the wheel 40 in the housing 40. The angle (α) is enlarged when the wheel 40 is moved together with the shaft 42 and the first and second coil parts 61, 62 from the upper position to the lower position by an external force acting on the exposed portion 401 of the wheel 40 so as to provide an urging force to move the wheel 40 together with the shaft 42 and the first and second coil parts 61, 62 from the lower position to the upper position when the wheel 40 is relieved from the external force.

Preferably, the first end sections 611, 621 of the first and second coil parts 61, 62 are disposed between the second end sections 612, 622 of the first and second coil parts 61, 62, and are integrally connected to and cooperate with each other to form a U-shaped part 63 of the spring unit 60. The housing 10 has a mounting arm 11 that projects inwardly therefrom at a front side of the wheel 40 and that is formed with a guide groove 111 which receives the U-shaped part 63 and which permits sliding movement of the U-shaped part 63 therein when the wheel 40 is moved in the radial direction.

The second end section 612 (622) of each of the first and second coil parts 61, 62 has an L-shaped free end 641. The housing 10 further has a pair of spaced apart pivot ears 12 that project inwardly therefrom at a rear side of the wheel 40 opposite to the mounting arm 11. The L-shaped free end 641 of the second end section 612 (622) of each of the first and second coil parts 61, 62 is pivoted to a respective one of the pivot ears 12 so as to permit rotation of the second end sections 612, 622 when the wheel 40 is moved in the radial direction. Each of the pivot ears 12 is formed with a pivot hole 120 that has a diameter which is slightly greater than a cross-section of the L-shaped free end 641 of the respective one of the second end sections 612, 622 so as to limit radial movement of the L-shaped free end 641.

In this embodiment, the wheel 40 is a type of optical encoder wheel that is formed with a plurality of angularly spaced apart radial slots 41, and that has an annular inner wall 44 that confines an inner space 45 and that is formed with a series of alternately disposed ridges 46 and grooves 43. The detecting unit includes a light transmitter 24 electrically connected to the circuit board 20 at the right side of the wheel 40 for generating a light to pass through the radial slots 41, a light receiver 25 electrically connected to the circuit board 20 at the left side of the wheel 40 for receiving the light from the light transmitter 24 and for generating one of the electrical signals to indicate the direction and amount of rotation of the wheel 40, and a third microswitch 23 electrically connected to the circuit board 20 and actuated by movement of the wheel 40 to the lower position for providing another one of the electrical signals to the computer. An actuator 50 includes a cylindrical mounting portion 51 disposed in the inner space 45, sleeved around the shaft 42 between the first and second coil parts 61, 62, and formed with a retaining notch 511 that engages the first end section 611 of the first coil part 61 so as to be held by the spring unit 60. The actuator 50 further includes a pressing plate 53 projecting from the mounting portion 51 outwardly of the inner space 45 for actuating the third microswitch 23 when the wheel 40 is moved to the lower position, and a friction member 52 projecting from the mounting portion 51 toward the inner wall 44 and having two opposing tongues 520 which releasably engage two of the grooves 43 so that rotation of the wheel 40 can be sensed by a digit of the user.

With the use of the spring unit 60 to suspend the wheel 40 in the housing 10, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

I claim:

1. A mouse adapted to provide electrical signals to a computer, said mouse comprising:
a housing;
a wheel mounted rotatably in said housing and having opposite left and right sides and a portion exposed from said housing for user operation;
a shaft extending in an axial direction through a center of said wheel and secured thereto, said shaft having two opposite ends disposed at said left and right sides of said wheel, respectively, said wheel being operable to move together with said shaft in a radial direction relative to said shaft from an upper position to a lower position;
a detecting unit disposed in said housing and adapted to provide electrical signals to the computer upon detecting movement of said wheel; and
a spring unit mounted in said housing and including opposing first and second coil parts, each of which is sleeved on a respective one of said opposite ends of said shaft so as to permit rotation of said wheel together with said shaft relative to said first and second coil parts and so as to be movable together with said wheel and said shaft in said radial direction, and each of which has opposing first and second end sections that diverge therefrom to define an angle therebetween and that slidably abut against said housing so as to permit mounting of said wheel in said housing, said angle being enlarged when said wheel is moved together with said shaft and said first and second coil parts from said upper position to said lower position by an external force so as to provide an urging force to move said wheel together with said shaft and said first and second coil parts from said lower position to said upper position when said wheel is relieved from the external force.

2. The mouse of claim 1, wherein said first end sections of said first and second coil parts are disposed between said second end sections of said first and second coil parts, and are integrally connected to and cooperate with each other to form a U-shaped part of said spring unit, said housing having a mounting arm that projects inwardly therefrom at a front side of said wheel and that is formed with a guide groove which receives said U-shaped part and which permits sliding movement of said U-shaped part therein when said wheel is moved in said radial direction.

3. The mouse of claim 2, wherein said second end section of each of said first and second coil parts has an L-shaped free end, said housing further having a pair of spaced apart pivot ears that project inwardly therefrom at a rear side of said wheel opposite to said mounting arm, said L-shaped free end of said second end section of each of said first and second coil parts being pivoted to a respective one of said pivot ears so as to permit rotation of said second end sections when said wheel is moved in said radial direction.

4. The mouse of claim 3, wherein said wheel has an annular inner wall that confines an inner space and that is formed with a series of alternately disposed ridges and grooves, said detecting unit including a microswitch mounted in said housing for providing one of the electrical signals to the computer upon actuation, said mouse further comprising an actuator that includes a cylindrical mounting portion disposed in said inner space, sleeved around said shaft between said first and second coil parts, and engaging said first end section of one of said first and second coil parts so as to be held by said spring unit, said actuator further including a pressing plate projecting from said mounting portion outwardly of said inner space for actuating said microswitch when said wheel is moved to said lower position, and a friction member projecting from said mounting portion toward said inner wall and having two opposing tongues which releasably engage two of said grooves upon rotation of said wheel by a digit of the user.
